(19) United States
(12) Patent Application Publication
(10) Pub. No.: US 2015/0131019 A1
(43) Pub. Date: May 14, 2015

(54) LIQUID CRYSTAL DRIVE METHOD AND LIQUID CRYSTAL DISPLAY DEVICE

(71) Applicant: Sharp Kabushiki Kaisha, Osaka-shi, Osaka (JP)

(72) Inventors: Yuichi Kita, Osaka-shi (JP); Takatomo Yoshioka, Osaka-shi (JP); Yoshiki Nakatani, Osaka-shi (JP)

(21) Appl. No.: 14/402,890

(22) PCT Filed: Apr. 22, 2013
(86) PCT No.: PCT/JP2013/061722

§ 371 Date: Nov. 21, 2014

(30) Foreign Application Priority Data
May 23, 2012 (JP) 2012-117983

(51) Int. Cl. G02F 1/133; G02F 1/1368; G02F 1/1343

(52) U.S. Cl. CPC G02F 1/13306; G02F 1/134309; G02F 1/1368
USPC 349/42; 349/33

(57) ABSTRACT

The present invention provides a liquid crystal driving method of sufficiently reducing DC image sticking together with flicker and a liquid crystal display device driven by using the liquid crystal driving method. The invention relates to a liquid crystal driving method of driving liquid crystal by causing a potential difference between a pair of electrodes provided for one of upper and lower substrates. Polarity of each of application voltages to the pair of electrodes is inverted, and a planar electrode is provided for the upper substrate and/or the lower substrate. When a difference obtained by subtracting a voltage applied to the planar electrode from an average value of a positive voltage and a negative voltage applied to one of the pair of electrodes is set as a first offset voltage and a difference obtained by subtracting a voltage applied to the planar electrode from an average value of a positive voltage and a negative voltage applied to the other one of the pair of electrodes is set as a second offset voltage, a driving operation that the values of the first and second offset voltages are switched with each other is executed.

### TECHNICAL FIELD

The present invention relates to a liquid crystal driving method and a liquid crystal display device. More specifically, the invention relates to a liquid crystal driving method and a liquid crystal display device performing display by applying an electric field using a pair of electrodes.

### BACKGROUND ART

A liquid crystal driving method is a method of moving liquid crystal molecules in a liquid crystal layer sandwiched by a pair of substrates, by generating an electric field between electrodes, thereby changing the optical characteristic of the liquid crystal layer and making light pass or not pass through a liquid crystal display device. Accordingly, an on state and an off state can be created.

By such liquid crystal driving, liquid crystal display devices of various modes are provided in various usages while advantages such as thinness, lightness, and lower power consumption are utilized. For example, various driving methods are devised and practically used in displays or the like of a personal computer, a television, and an in-vehicle device such as a car navigation, and a display of a portable information terminal such as a smartphone or a tablet terminal.

For a liquid crystal display device, various display methods (display modes) are being developed depending on the characteristic of liquid crystals, electrode disposition, substrate design, and the like. Display modes widely used in recent years are, broadly, a vertical alignment (VA) mode in which liquid crystal molecules having negative anisotropy of dielectric constant are aligned vertically to the substrate surface, an in-plane switching (IPS) mode of making liquid crystal molecules having positive or negative anisotropy of dielectric constant aligned to be horizontal to the substrate surface and applying transverse electric field, a fringe field switching (FFS) mode, and the like. In those display modes, some liquid crystal driving methods and electrode structures used for the methods are proposed.

For example, as a liquid crystal display device of the IPS method, a liquid crystal display device is disclosed, in which a pixel is formed in a region surrounded by scan lines extending in a first direction and arranged in a second direction and video signal lines extending in the second direction and arranged in the first direction. The pixel has a first electrode formed in a solid plane, an interlayer insulating film formed on the first electrode, and a second electrode formed on the interlayer insulating film. The second electrode has first and second regions. The first region has first number of comb-teeth electrodes, the second region has second number of comb-teeth electrodes, and the first number and the second number are different from each other (see, for example, patent literature 1).

### CITATION LIST

### Patent Literature

Patent Literature 1: JP 2010-2596 A

### SUMMARY OF INVENTION

### Technical Problem

For example, in the IPS driving method, the position of a bright part on a line and that on a space are switched every polarity inversion by flexo-electric polarization (flexoelectricity). To eliminate a luminance change caused by the phenomenon, for example, the number of lines and the number of spaces are set to the same.

However, since a bright part is not switched between the position on a line and the position on a space in the TBA mode, the on-on switching mode, and the like, the above-described method cannot be applied. Since the pixel structure is regulated, a flicker cannot be completely canceled out depending on the size of a pixel.

The present invention has been achieved in view of the above-described circumstances and its object is to provide, in a liquid crystal driving method of driving liquid crystal by causing a potential difference between a pair of electrodes provided for one of upper and lower substrates, a liquid crystal driving method of sufficiently reducing a DC image sticking as well as a flicker and a liquid crystal display device driven by using the liquid crystal driving method.

### Solution to Problem

The inventors of the present invention have found that, in a liquid crystal display device determining alignment of liquid crystal by an electric field containing a transverse component (for example, a TBA (Transverse Bend Alignment) mode, an on-on switching mode, or the like), at the time of generating an electric field (for example, an electric field in the horizontal direction for the substrate main surface) containing a transverse component by a pair of comb-teeth electrodes such as upper-layer comb-teeth electrodes, there is a region in which the liquid crystal is bend-aligned or spray-aligned. Due to this, a flexo-electric polarization by the flexo-electric effect occurs, and a transmittance difference occurs between the case where a voltage applied to one of a pair of electrodes is positive and the case where the voltage is negative (hereinbelow, also called “the difference of transmittance between the positive polarity and the negative polarity). In short, the inventors of the present invention found out a problem that a flicker occurs in polarity reversal between the positive polarity and the negative polarity in the case of applying a voltage of the same magnitude to the electrodes.

The inventors of the present invention examined the cause and found out that, in a mode of determining alignment of the liquid crystal by an electric field containing a transverse component, the liquid crystal is aligned obliquely, so that the spray alignment and the bend alignment occur. When such alignment occurs, symmetry of molecule arrangements of the liquid crystal is lost, and macroscopic polarization (flexo-electric polarization) occurs. They also found that such flexo-electric polarization is a phenomenon which is seen in all of nematic liquid crystals regardless of the form of a molecule. Since a difference in alignment occurs between the positive polarity and the negative polarity due to occurrence of the flexo-electric polarization, the transmittance varies.

In a liquid crystal display device having a three-layer electrode structure of a vertical alignment type, the inventors of the present invention pay attention to a liquid crystal display device of an on-on switching mode, by comb-teeth driving an upper-layer electrode in a lower-side substrate, generating a transverse electric field by a potential difference between the comb teeth at a rise, generating a vertical electric field by a potential difference between substrates at a fall, rotating liquid crystal molecules by the electric fields both at the rise and fall to achieve higher response, and also realizing high transmittance by the transverse electric field of comb-teeth driving, and examine it variously (for example, Japanese Patent Application No. 2011-142346, Japanese Patent Application No. 2011-142351, and the like).

The inventors of the present invention found that, since flexo-electric polarization always occurs in this mode, the transmittance difference accompanying the polarity reverse between the positive and negative polarities caused by the flex-electric polarization, that is, the above-described flicker occurs. It can be said that a problem of causing such a flicker is particularly large in a liquid crystal display device in which liquid crystal molecules are aligned vertical to the substrate main surface at the time of applying no voltage and are aligned horizontally at the time of display.

Except for the above, flexo-electric polarization tends to occur in modes in which the liquid crystal is driven by a transverse electric field (such as TBA mode, IPS mode, and the like). Consequently, luminance changes between positive polarity and negative polarity, so that a flicker easily occurs and display quality deteriorates. To solve the problem, attention has been paid to the technique of making luminance in the positive polarity and that in the negative polarity the same by applying an offset voltage. However, since DC voltage is applied always in a fixed direction, image sticking occurs.

The present inventors have made detailed examination to solve such a flicker in a driving method of driving liquid crystal by an electric field including a transverse component. To suppress a flicker, it is sufficient to adjust the transmittance difference between the positive and negative polarities by applying an electric offset (offset voltage) to electrodes. In this case, DC image sticking caused by a DC (Direct Current) offset becomes an issue.

For example, FIG. 15 is a sectional schematic diagram of a liquid crystal display device in a normal transverse electric field mode in the case where an offset voltage is 0.2V. In the transverse electric field mode, since flexo-electric polarization occurs, a flicker occurs. To solve the flicker, an offset voltage is applied between an electrode driven by pixel by a TFT (a TFT-driven electrode 417) and a common electrode (an electrode shared by a plurality of pixels) 419. Since the offset voltage is always applied to the TFT-driven electrode 417, a DC voltage of 0.2V is always applied in the direction from the common electrode 419 toward the TFT-driven electrode 417, and DC image sticking occurs. In FIG. 15, the arrow extends from the electrode as a reference toward the electrode to which the offset voltage is applied (the offset voltage may be 0V), and the value of the offset voltage of the electrode to which the offset voltage is applied with respect to the electrode as the reference (the value obtained by subtracting the voltage of the electrode as the reference from the voltage of the electrode to which the offset value is applied) is shown. It is also similarly applied to the other drawings.

The present inventors have examined the liquid crystal driving method capable of sufficiently suppressing DC image sticking together with a flicker under such a situation and, as a result, reached a novel technical idea such that since image sticking occurs due to application of DV voltage in a fixed direction, voltage is applied so as to cancel out the DC voltage.

Concretely, two or more TFTs are prepared per pixel. For example, both of electrodes of a pair of comb-teeth electrodes are TFT-driven (FIG. 1 and the like). A reference potential is applied to one of the two TFTs and a potential for determining a gray scale (gray-scale potential) is applied to the other TFT. The present inventors have found that, by switching the reference potential and the gray-scale potential at predetermined timings, the offset voltage is applied in opposite directions, so that image sticking is reduced. The present inventors have found that such a liquid crystal driving method can be suitably applied particularly to a liquid crystal display device having a three-layer electrode structure of a vertical alignment type and can be also suitably applied to another liquid crystal display device in which alignment of liquid crystal is determined by an electric field including a transverse component. These findings have led to solution of the problem and completion of the present invention.

The different point from the above-described related art literature is that a voltage application method is changed regardless of a pixel structure.

The present invention relates to a method of driving liquid crystal by causing a potential difference between a pair of electrodes provided for one of upper and lower substrates. Polarity of each of application voltages to the pair of electrodes is inverted. A planar electrode is provided for the upper substrate and/or the lower substrate. In the liquid crystal driving method, when a difference obtained by subtracting a voltage applied to the planar electrode from an average value of a positive voltage and a negative voltage applied to one of the pair of electrodes is set as a first offset voltage and a difference obtained by subtracting a voltage applied to the planar electrode from an average value of a positive voltage and a negative voltage applied to the other one of the pair of electrodes is set as a second offset voltage, a driving operation that the values of the first and second offset voltages are switched with each other is executed. In other words, the application direction of the offset voltage is reversed between the pair of comb-teeth electrodes. The liquid crystal is usually sandwiched between the upper and lower substrates.

The description that the values of the first and second offset voltages are switched with each other denotes, for example, switching from a state that the first offset voltage is +0.2V and the second offset voltage is zero to a state that the first offset voltage is zero and the second offset voltage is +0.2V.

The offset voltage has a value indicating a deviation of the average value of a positive voltage and a negative voltage at the time of performing polarity reverse with respect to a certain reference (in the specification, for example, the opposed voltage of the opposed electrode).

The “first offset voltage as the difference obtained by subtracting a voltage applied to the planar electrode from an average value of the positive voltage and the negative voltage applied to one of the pair of electrodes” according to the liquid crystal driving method of the present invention is an average value between a voltage applied to one of the pair of electrodes with respect to the voltage applied to the planar electrode as a reference at the time of applying the positive voltage to one of the pair of electrodes and a voltage applied to one of the pair of electrodes with respect to the voltage applied to the planar electrode as a reference at the time of applying the negative voltage to one of the pair of electrodes. The “second offset voltage as the difference obtained by subtracting a voltage applied to the planar electrode from an average value of the positive voltage and the negative voltage applied to the other one of the pair of electrodes” according to the present invention is similarly an average value between a voltage applied to the other one of the pair of electrodes with respect to the voltage applied to the planar electrode as a reference at the time of applying the positive voltage to the other one of the pair of electrodes and a voltage applied to the other one of the pair of electrodes with respect to the voltage applied to the planar electrode as a reference at the time of applying the negative voltage to the other one of the pair of electrodes. The average value of the positive voltage and the negative voltage can be also said as a value obtained by adding the positive and negative voltages and dividing the resultant by two.

For example, when the opposed voltage is set to 0V (which becomes the reference of an offset), in the case of applying +7.1V as a positive voltage and −7.5V as a negative voltage to a certain electrode (for example, the other one of a pair of electrodes), (+7.1V−7.5V)/2=−0.2V is an offset value. That is, when the values are expressed to clearly show the offset value, “+7.1V−7.5V” can be rewritten as “±7.3V−0.2V”, and the value is deviated from the average 0V by the amount of −0.2V.

Each of the positive voltage/negative voltage applied to one of the pair of electrodes, the positive voltage/negative voltage applied to the other one of the pair of electrodes, and the voltage applied to the planar electrode is preferably fixed but may change as long as the effect of the present invention can be exerted. In the case where each of the voltages changes, each of the voltages can be set as an average value of the voltage.

The inversion of the polarity of the application voltage in the specification includes a change of the absolute value itself of the application voltage. The polarity of each of the voltages applied to the pair of electrodes in the present invention is usually inverted every predetermined period.

In the liquid crystal driving method of the present invention, a planar electrode as a reference of the offset voltage may be an electrode (for example, a lower-layer electrode) for a lower-side substrate (circuit substrate) or an electrode for an upper-side substrate (opposed substrate). Preferably, the electrode of the upper-side substrate (opposed substrate) which usually does not have both positive and negative values is set as a reference of the offset voltage. That is, in the liquid crystal driving method of the present invention, preferably, a planar electrode is provided for at least the other one of the upper and lower substrates, a difference obtained by subtracting a voltage applied to the planar electrode provided for the other one of the upper and lower substrates from an average value of a positive voltage and a negative voltage applied to one of the pair of electrodes is set as a first offset voltage, and a difference obtained by subtracting the voltage applied to the planar electrode provided for the other one of the upper and lower substrates from an average value of a positive voltage and a negative voltage applied to the other one of the pair of electrodes is set as a second offset voltage.

The voltage applied to the pair of electrodes is usually an alternating-current (AC) voltage. The AC voltage is a voltage whose magnitude changes periodically with time. Usually, the potential changes so that amplitudes having substantially the same magnitude are obtained in the upper and lower sides of the center voltage. The liquid crystal driving method of the present invention is not limited to this.

In the liquid crystal driving method of the present invention, preferably, the pair of electrodes is constructed by an electrode (gray-scale electrode) which sets a voltage in accordance with a gray scale and changes an application voltage to express gray-scale luminance and an electrode (reference electrode) which basically fixes a voltage regardless of a gray scale and becomes a reference for the gray-scale electrode, the first offset value and the second offset value are switched with each other and, at the same time, the gray-scale electrode and the reference electrode in the pair of electrodes are switched with each other.

In the liquid crystal driving method of the present invention, preferably, the polarity of the first offset voltage and that of the second offset voltage are opposite to each other and the absolute value of the first offset voltage and that of the second offset voltage are the same. The polarity of the offset voltage indicates a difference between a positive offset voltage and a negative offset voltage. In the liquid crystal driving method of the present invention, in the case where the polarity of the first offset voltage and that of the second offset voltage are opposite to each other, a mode that the first offset voltage is positive and the second offset voltage is negative and a mode that the first offset voltage is negative and the second offset voltage is positive are alternately switched.

Accordingly, an offset in the vertical direction is also cancelled out, and DC image sticking is further suppressed. The term “the same” includes the case where the absolute values are almost the same in the technical field of the present invention as long as the effect of reducing the offset in the vertical direction can be sufficiently displayed. For example, the difference between the absolute value of the first offset voltage and the absolute value of the second offset voltage may be 200 mV or less, and therefore, the effect that an offset in the vertical direction is reduced can be sufficiently displayed. More preferably, the difference between the absolute value of the first offset voltage and the absolute value of the second offset voltage is 100 mV or less.

Preferably, the driving operation that the value of the first offset voltage and that of the second offset voltage are switched with each other at predetermined time intervals is executed. The predetermined time may be “substantially predetermined” time as long as the effect of the present invention is displayed.

For example, the pair of electrodes is preferably a pair of comb-teeth electrodes. More preferably, two comb-teeth electrodes face each other in plan view of the substrate main surface. Since a transverse electric field can be suitably generated between the comb-teeth electrodes, when a liquid crystal layer includes liquid crystal molecules having positive anisotropy of dielectric constant, the response and transmittance at the time of a rise become excellent. When a liquid crystal layer includes liquid crystal molecules having negative anisotropy of dielectric constant, the liquid crystal molecules are rotated by the transverse electric field at the time of a fall to realize higher response. Preferably, each of the comb-teeth parts in the pair of comb-teeth electrodes are along in plan view of the substrate main surface. Particularly, it is preferable that each of the comb-teeth parts of the pair of comb-teeth electrodes are almost parallel, in other words, each of the pair of comb-teeth electrodes has a plurality of slits which are almost parallel. Usually, one comb-teeth electrode has two or more comb-teeth parts.

A pair of comb-teeth electrodes may be provided for the same layer or, as long as the effect of the present invention can be displayed, may be provided for different layers. Preferably, a pair of electrodes is provided for the same layer. The meaning that a pair of electrodes is provided for the same layer indicates that each of the electrodes is in contact with common members (for example, an insulting film, a liquid crystal layer, and the like) on the liquid crystal layer side and/or the side opposite to the liquid crystal layer side.

The above description “a planar electrode is provided for the upper substrate and/or the lower substrate” denotes any of (1) a mode that planar electrodes are provided for both of the upper and lower substrates, (2) a mode that a planar electrode is provided for only one of the upper and lower substrates (the substrate on which a pair of electrodes are disposed), or (3) a mode that a planar electrode is provided for the other one of the upper and lower substrates. Each of the modes (1) to (3) will be specifically described.

In the case where the planar electrodes are provided for both of a pair of substrates, for anyone of the planar electrodes, it is sufficient to set an average value of amounts obtained by adding positive and negative voltages applied to one of a pair of electrodes as a first offset voltage and set an average value of amounts obtained by adding positive and negative voltages applied to the other one of the pair of electrodes as a second offset voltage. In this case, as described above, it is preferable to set the planar electrode on the upper substrate (opposed substrate) side as a reference. That is, for the planar electrode on the upper substrate (opposed substrate) side, it is preferable to set an average value of amounts obtained by adding positive and negative voltages applied to one of a pair of electrodes as a first offset voltage and set an average value of amounts obtained by adding positive and negative voltages applied to the other one of the pair of electrodes as a second offset voltage.
(1) In the liquid crystal driving method of the present invention, after the driving operation, further, it is preferable to execute a driving operation of driving liquid crystal by causing a potential difference between a pair of electrodes constructed by planar electrodes provided for both upper and lower substrates. It is sufficient that the planar electrode has a planar shape in correspondence with (superimposing) pixels in plan view of a substrate main surface. In this case, the liquid crystal driving method of the present invention is a method of driving liquid crystal by causing a potential difference between two pairs of electrodes provided for upper and lower substrates, and response speed is particularly excellent. When planar electrodes are provided for both of upper and lower substrates, at the time of obtaining an offset voltage, any of the planar electrodes may be used as a reference. For example, as described above, the planar electrode provided for the other one (opposed substrate) of the upper and lower substrates can be used as a reference.

In other words, in the liquid crystal driving method, preferably, further, a driving operation of driving the liquid crystal by causing a potential difference between a pair of planar electrodes is executed. Usually, the pair of planar electrodes can give a potential difference between substrates. Consequently, at the time of a fall when the liquid crystal layer includes liquid crystal molecules having positive anisotropy of dielectric constant and at the time of a rise when the liquid crystal layer includes liquid crystal molecules having negative anisotropy of dielectric constant, a vertical electric field is generated by the potential difference between the substrates, and the liquid crystal molecules are rotated by the electric field, so that higher response can be achieved. For example, at the time of a fall, by the electric field generated between the upper and lower substrates, the liquid crystal molecules in the liquid crystal layer are rotated so as to be in a direction perpendicular to the substrate main surface, and higher response can be achieved.

In the specification, the planar electrode includes a form electrically connected in a plurality of pixels. For example, a form that the planar electrode is electrically connected in all of pixels, a form that the planar electrode is electrically connected in the same pixel row, and the like are preferable. The planar shape may be a plane shape in the technical field of the present invention and may have an alignment regulation structure such as a rib, a slit, or the like in a region in a part of the shape, or may have the alignment regulation structure in the center part of a pixel in plan view of the substrate main surface. It is however preferable not to have an alignment regulation structure. Preferably, the planar electrode provided for one of the pair of substrates has, at least, a plane shape in apart superimposing pixels in a plan view of the substrate main surface. Preferably, the planar electrode provided for the other one (opposed substrate) of the pair of substrates has no opening. The preferable structure of the above described electrode is similarly applied also to the following forms (2) and (3).
(2) In the liquid crystal driving method of the present invention, preferably, a planar electrode is provided for only one of the upper and lower substrates. In the liquid crystal driving method of the present invention, preferably, a pair of electrodes provided for one of the upper and lower substrates are provided over the planar electrode with an insulating film interposed therebetween.
(3) In the liquid crystal driving method of the present invention, preferably, a planar electrode is disposed in only the other one of the upper and lower substrates.

In the liquid crystal driving method of the present invention, preferably, a dielectric layer is provided for at least one of the upper and lower substrates. For example, it is preferable that a dielectric layer is provided for the other one of the upper and lower substrates.

Further, in the liquid crystal driving method of the present invention, preferably, one of the upper and lower substrates has a thin film transistor element, and the thin film transistor element includes an oxide semiconductor.

The liquid crystal driving method relates to a method of performing driving by an active matrix driving method. In the active matrix driving method, preferably, driving is performed by a plurality of bus lines using a thin film transistor, and a driving operation is executed by inverting a potential change applied to an electrode in the N-th bus line and an electrode in the (N+1)th bus line. The inversion of the potential change applied to the electrode in the N-th bus line and the electrode in the (N+1)th bus line is carried out by making a positive potential change and a negative potential change to a certain potential. As the bus lines, a gate bus line and a source bus line can be referred to.

In the liquid crystal driving method of the present invention, preferably, the liquid crystal includes liquid crystal molecules aligned in a direction perpendicular to a substrate main surface when no voltage is applied. As the alignment in the direction perpendicular to the substrate main surface, it is sufficient that it can be said that the liquid crystal molecules are aligned in the direction perpendicular to the substrate main surface in the technical field of the present invention. The alignment includes a mode that the liquid crystal molecules are substantially aligned in the perpendicular direction. Preferably, the liquid crystal is substantially constructed by liquid crystal molecules aligned in the direction perpendicular to the substrate main surface when no voltage is applied. The description “when no voltage is applied” may be a state where it can be said no voltage is substantially applied in the technical field of the present invention. The liquid crystal in such a perpendicular alignment type is advantageous to obtain characteristics such as wide view angle and high contrast, so that its application usages are enlarged.

In the mode (1) and the mode (3), the driving operation is a driving operation of driving the liquid crystal by causing a potential difference between a pair of electrodes.

The pair of comb-teeth electrodes can usually make a potential different at a threshold voltage or higher. The threshold voltage means, for example, a voltage value which gives transmittance of 5% when transmittance in a light state is set to 100%. In the description that a potential can be made different at the threshold voltage or higher, it is sufficient to realize a driving operation of making the potential different at the threshold voltage or higher. Consequently, an electric field applied to a liquid crystal layer can be suitably controlled. A preferred upper-limit value of a different potential is, for example, 20V. As a configuration capable of making a potential different, for example, one of a pair of electrodes is driven by a TFT, and the other electrode is driven by another TFT, or a lower-layer electrode of the other electrode is made conductive to the other electrode, thereby making potentials of the pair of comb-teeth electrodes different from each other. In the case where the pair of comb-teeth electrodes are a pair of comb-teeth electrodes, preferably, the width of a comb-teeth part in the pair of comb-teeth electrodes is, for example, 2 μm or larger. Preferably, the width between the comb-teeth parts (also called a space in the specification) is, for example, 2 μm to 7 μm.

Preferably, when the potential difference in the pair of comb-teeth electrodes becomes a threshold voltage or larger, the liquid crystal is aligned including a horizontal component with respect to the substrate main surface. As the alignment in the horizontal direction, it is sufficient that the liquid crystal is aligned in the horizontal direction in the technical field of the present invention. With the configuration, higher response can be achieved and, in the case where the liquid crystal includes liquid crystal molecules (positive liquid crystal molecules) having positive anisotropy of dielectric constant, the transmittance can be improved. The liquid crystal is, preferably, substantially constructed by liquid crystal molecules aligned in a direction horizontal to the substrate main surface at the threshold voltage or higher.

Preferably, the liquid crystal includes liquid crystal molecules having positive anisotropy of dielectric constant (positive liquid crystal molecules). The liquid crystal molecules having the positive anisotropy of dielectric constant are aligned in a certain direction when an electric field is applied to the liquid crystal. The alignment control is easy, and higher response can be achieved. Moreover, the liquid crystal layer preferably includes liquid crystal molecules having negative anisotropy of dielectric constant (negative liquid crystal molecules). With the configuration, transmittance can be further improved. That is, from the viewpoint of increasing response, it is preferable that the liquid crystal molecules are substantially constructed by the liquid crystal molecules having the positive anisotropy of dielectric constant. From the viewpoint of transmittance, it is preferable that the liquid crystal molecules are substantially constructed by the liquid crystal molecules having the negative anisotropy of dielectric constant.

In the upper and lower substrates, usually, an alignment film is provided on at least one of liquid crystal layer sides. The alignment film is preferably a perpendicular alignment film. As the alignment film, an alignment film formed of an organic material or an inorganic material, a photo-alignment film formed of a photoactive material, an alignment film subjected to an alignment process by rubbing or the like, and the like can be mentioned. The alignment film may be an alignment film which is not subjected to the alignment process such as a rubbing process. By using an alignment film requiring no alignment process such as an alignment film formed of an organic material or an inorganic material or a photo-alignment film, the process is simplified to reduce the cost, and reliability and the yield can be improved. In the case of performing the rubbing process, there is the possibility of occurrence of display unevenness due to liquid crystal contamination caused by impurity incorporation from rubbing cloth or the like, point defect failure caused by a foreign matter, unevenness of rubbing in a liquid crystal panel. By using the alignment film requiring no alignment process, such disadvantages can be eliminated. The upper and lower substrates preferably have a polarizing plate on the side opposite to the side of at least one of the liquid crystal layers. As the polarizing plate, a circular polarizing plate is preferable. With such a configuration, the transmittance improving effect can be further displayed. The polarizing plate is also preferably a linear polarizing plate. With such a configuration, the view angle characteristic can be made excellent.

The upper and lower substrates of the liquid crystal panel of the present invention are usually a pair of substrates for sandwiching liquid crystal and are formed by, for example, using an insulating substrate made of glass, resin or the like as a body and forming wires, electrodes, color filters, and the like on the insulating substrate. In the liquid crystal driving method of the present invention, preferably, at least one of the upper and lower substrates is provided with a dielectric layer.

Preferably, at least one of the pair of comb-teeth electrodes is a pixel electrode, and one of the pair of substrates is an active matrix substrate. The liquid crystal driving method of the present invention can be applied to a liquid crystal display device of any of a transmission type, a reflection type, and a transflective type.

The present invention also relates to a liquid crystal display device driven by using the liquid crystal driving method of the present invention. A preferable mode of the liquid crystal driving method in the liquid crystal display device of the present invention is similar to that of the above-described liquid crystal driving method of the present invention. As liquid crystal display devices, displays of a personal computer, a television, and an in-vehicle device such as a car navigation, and a display of a portable information terminal such as a smartphone or a tablet terminal can be mentioned. Particularly, in a liquid crystal display device having a three-layer electrode structure of a vertical alignment type, in a mode capable of high-speed responding by rotating liquid crystal molecules by an electric field at each of a rise and a fall, the response is very excellent. Consequently, the invention can be preferably applied to applications such as an in-vehicle liquid crystal display device such as a car navigation which may be used under low-temperature environment or the like, a liquid crystal display device of a field sequential type, and a 3D (stereoscopic) display device.

The configuration of the liquid crystal driving method and a liquid crystal display device of the present invention is not especially limited as long as it essentially includes such components. The configuration may or may not include other components which are usually used for a liquid crystal driving method and a liquid crystal display device.

### Advantageous Effects of Invention

According to the present invention, in a liquid crystal driving method of driving a liquid crystal by causing a potential difference in a pair of electrodes provided for one of upper and lower substrates, a DC image sticking as well as a flicker can be reduced sufficiently.

### BRIEF DESCRIPTION OF DRAWINGS

FIG. 1 is a sectional schematic diagram illustrating a mode at the time of generation of a transverse electric field of a liquid crystal display device in a transverse electric field mode according to a first embodiment.

FIG. 2 is a sectional schematic diagram illustrating a mode at the time of generation of a transverse electric field of the liquid crystal display device in a transverse electric field mode according to the first embodiment.

FIG. 3 is a sectional schematic diagram at the time of generation of a transverse electric field of a liquid crystal display device according to a first embodiment.

FIG. 4 is a sectional schematic diagram at the time of generation of a vertical electric field of the liquid crystal display device according to the first embodiment.

FIG. 5 is a sectional schematic diagram illustrating a mode at the time of generation of a transverse electric field of the liquid crystal display device according to the first embodiment.

FIG. 6 is a sectional schematic diagram indicating a mode at the time of generation of a transverse electric field of a liquid crystal display device according to a first embodiment.

FIG. 7 is a sectional schematic diagram illustrating a mode at the time of generation of a transverse electric field of a liquid crystal display device according to a second embodiment.

FIG. 8 is a sectional schematic diagram illustrating a mode at the time of generation of a transverse electric field of the liquid crystal display device according to the second embodiment.

FIG. 9 is a sectional schematic diagram illustrating a mode at the time of generation of a transverse electric field of the liquid crystal display device according to a third embodiment.

FIG. 10 is a sectional schematic diagram illustrating a mode at the time of generation of a transverse electric field of a liquid crystal display device according to the third embodiment.

FIG. 11 is a sectional schematic diagram illustrating an example of a liquid crystal display device used for the liquid crystal driving method of the embodiment.

FIG. 12 is a plan schematic view of the periphery of an active driving element used for the embodiment.

FIG. 13 is a sectional schematic diagram illustrating the periphery of an active driving element used for the embodiment.

FIG. 14 is a diagram illustrating an example of an evaluation image.

FIG. 15 is a sectional schematic diagram of a liquid crystal display device of a transverse electric field mode according to Comparative Example 1.

### DESCRIPTION OF EMBODIMENTS

The present invention will be mentioned in more detail referring to the drawings in the following embodiments, but is not limited to these embodiments. In the specification, unless otherwise specified, a pixel may be a picture element (sub-pixel). For example, a dot-shaped rib and/or a slit may be formed in a planar electrode as long as the planar electrode is called a planar electrode in the technical field of the present invention. It is, however preferable that a planar electrode does not substantially have an alignment regulation structure.

A pair of substrates sandwiching a liquid crystal layer is also called upper and lower substrates. A substrate on the display surface side is also called an upper-side substrate, and a substrate on the side opposite to the display surface is also called a lower-side substrate. An electrode on the display surface side in electrodes disposed for substrates is also called an upper-layer electrode, and an electrode on the side opposite to the display surface is also called a lower-layer electrode. Further, since a circuit substrate (lower-side substrate) in the embodiments has a thin film transistor (TFT) device, it is also called a TFT substrate or an array substrate. In the case of an on-on switching mode in a first embodiment, a second embodiment, and a modification of a third embodiment, a TFT is set to an on state and voltage is applied to at least an electrode (pixel electrode) as one of a pair of comb-teeth electrodes at both a rise (application of a transverse electric field) and a fall (application of a vertical electric field).

In the embodiments, unless otherwise specified, the same reference numeral is designated to members and parts displaying similar functions. In the drawings, unless otherwise specified, (i) indicates a potential of one of comb-teeth electrodes in an upper layer in a lower-side substrate, (ii) indicates a potential of the other one of the comb-teeth electrodes in the upper layer in the lower-side substrate, (iii) indicates either a potential of a planar electrode of a lower layer of the lower-side substrate or a potential of a planar electrode of an upper-side substrate, and (iv) indicates a potential of the planar electrode of the upper-side substrate.

The reference electrode is basically an electrode fixing a voltage regardless of a gray scale and serving as a reference of a gray-scale electrode. In some cases, a change is made depending on a gray scale. A gray-scale electrode is an electrode setting a voltage in accordance with a gray scale and making a change to mainly express gray-scale brightness. In an on-on switching mode and a TBA mode, the gray-scale electrode is also called one of a pair of comb-teeth electrodes of the lower-side substrate, and the reference electrode is also called the other one of the pair of comb-teeth electrodes of the lower-side substrate.

### Embodiment 1 (Reversal of Gray-Scale Electrode and Reference Electrode Between Electrodes 17 and 19 (Reversal of Voltage Applied))

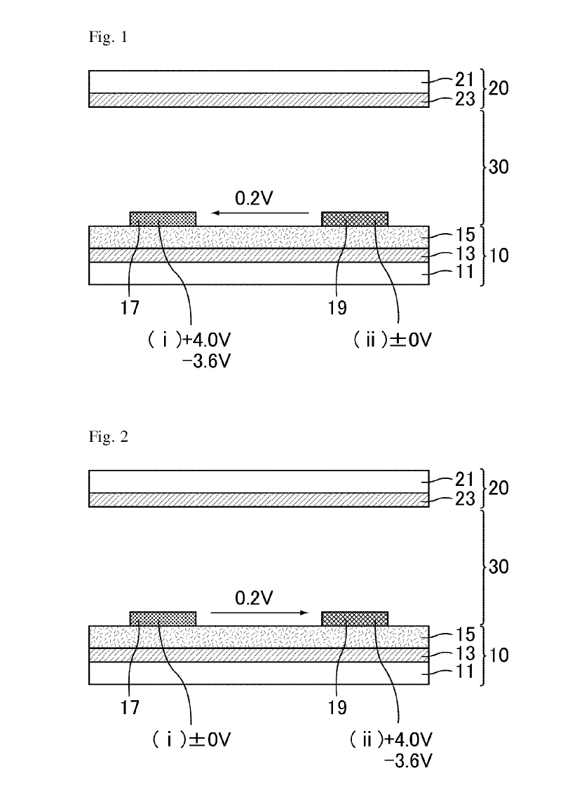

FIGS. 1 and 2 are sectional schematic diagrams illustrating a mode at the time of generation of a transverse electric field of a liquid crystal display device in a transverse electric field mode according to a first embodiment. FIGS. 1 and 2 illustrate the case where an offset voltage (in this case, the offset voltage is an offset voltage to an electrode 17 when an electrode 19 is set as a reference) is 0.2V.

In the first embodiment, the electrode 17 is TFT-driven and the electrode 19 is also TFT-driven. A gray-scale electrode and a reference electrode are switched between the electrodes 17 and 19 at predetermined time intervals (voltage to be applied is reversed at predetermined time intervals), thereby reversing the electrode to which the offset voltage is applied. Consequently, DC voltages applied between the electrodes 17 and 19 are reversed between the electrodes, so that the DC voltages cancel out each other and image sticking is reduced.

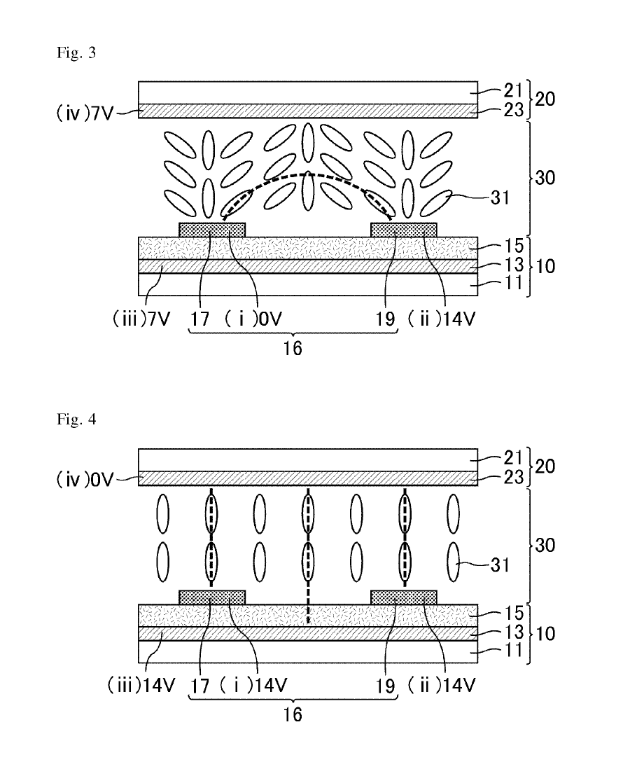

Next, outline of an on-on switching mode will be described. FIG. 3 is a sectional schematic diagram at the time of generation of a transverse electric field of a liquid crystal display device according to a first embodiment. FIG. 4 is a sectional schematic diagram at the time of generation of a vertical electric field of the liquid crystal display device according to the first embodiment. In FIGS. 3 and 4, dotted lines indicate the direction of an electric field generated. A liquid crystal display device according to the first embodiment has a three-layer electrode structure of a vertical alignment type using liquid crystal molecules 31 as a positive-type liquid crystal (an upper-layer electrode of a lower-side substrate positioned in the second layer is a comb-teeth electrode). At the time of rise, as illustrated in FIG. 3, the liquid crystal molecules are turned by a transverse electric field generated at a potential difference 14V between a pair of comb-teeth electrodes 16 (for example, including a reference electrode 17 of potential 0V and a gray-scale electrode 19 of potential 14V). Since the potential difference between substrates (an opposed electrode 13 of potential 7V and an opposed electrode 23 of potential 7V) does not substantially occur. An offset in the embodiment is not illustrated in FIG. 3.

At the time of fall, as illustrated in FIG. 4, the liquid crystal molecules are turned by a vertical electric field generated by the potential difference of 14V between the substrates (for example, between the opposed electrode 13, the reference electrode 17, and the gray-scale electrode 19 each having a potential of 14V and the opposed electrode 23 having a potential of 0V). A potential difference between the pair of comb-teeth electrodes 16 (for example, including the reference electrode 17 having a potential of 14V and the gray-scale electrode 19 having a potential of 14V) does not substantially occur.

By turning the liquid crystal molecules by the electric field at both rise and fall, the speed of a response increases. That is, at the time of rise, the on state is obtained by the transverse electric field generated between the pair of comb-teeth electrodes, and the transmittance becomes higher. At the time of fall, the on state is obtained by the vertical electric field between the substrates, and the speed of a response increases. Further, higher transmittance can be also realized by the transverse electric field of comb-teeth driving. In the first and subsequent embodiments, a positive-type liquid crystal is used as the liquid crystal. However, a negative-type liquid crystal may be used in place of the positive-type liquid crystal. In the case of using a negative-type liquid crystal, the liquid crystal molecules are aligned in the horizontal direction by the potential difference between the pair of substrates, and the liquid crystal molecules are aligned in the horizontal direction by the potential difference between the pair of comb-teeth electrodes. The transmittance becomes excellent, the liquid crystal molecules are rotated by the electric field at both rise and fall, and the speed of a response can be increased. In this case, it is preferable to execute, in order, a driving operation of causing the potential difference between the opposed electrodes disposed in upper and lower substrates and then a driving operation of causing the potential difference between the pair of comb-teeth electrodes. In the case of using a positive-type liquid crystal, it is preferable to execute, in order, a driving operation of causing the potential difference between a pair of comb-teeth electrodes and then a driving operation of causing the potential difference between the opposed electrodes disposed in the upper and lower substrates. In the first embodiment, the potentials of the pair of comb-teeth electrodes are indicated by (i) and (ii), the potential of the planar electrode in the lower substrate is indicated by (iii), and the potential of the planar electrode of the upper substrate is indicated by (iv).

The liquid crystal display panel according to the first embodiment is constructed by stacking, as illustrated in FIGS. 3 and 4, an array substrate 10, a liquid crystal layer 30, and an opposed substrate 20 (color filter substrate) in this order from the rear surface side of the liquid crystal display panel toward an observation surface side. In the liquid crystal display panel of the first embodiment, when the voltage difference between the pair of comb-teeth electrodes 16 is less than a threshold voltage (or when no voltage is applied), the liquid crystal molecules are vertically aligned. As illustrated in FIG. 3, when the voltage difference between the comb-teeth electrodes is equal to or higher than the threshold voltage, by making the liquid crystal molecules tilted in the horizontal direction between the comb-teeth electrodes by the electric field generated between the reference electrode 17 and the gray-scale electrode 19 (a pair of comb-teeth electrodes 16) as upper-layer electrodes formed above a glass substrate 11 (lower-side substrate), a transmission light amount is controlled. The lower-layer electrode (opposed electrode) 13 having a planar shape is formed by sandwiching an insulating film 15 between the reference electrode 17 and the gray-scale electrode 19 (a pair of comb-teeth electrodes 16). For the insulating film 15, for example, an oxide film SiO₂, a nitride film SiN, an acrylic resin, or the like is used, or a combination of those materials can be used.

### Electrode Reversing Method of Embodiment 1

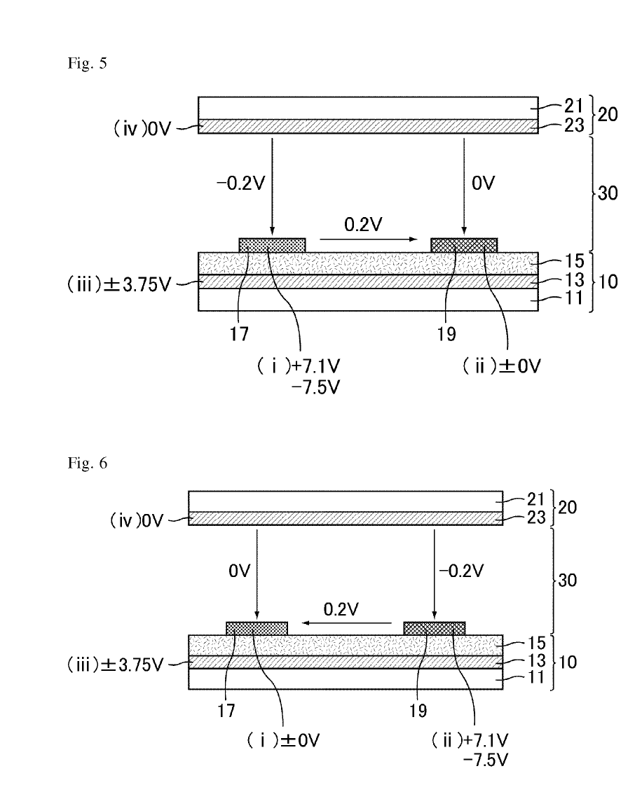

FIGS. 5 and 6 are sectional schematic diagrams illustrating a mode at the time of generation of the transverse electric field of the liquid crystal display device according to the first embodiment. In the first embodiment, a voltage applying method illustrated in FIG. 5 is called pattern A, and a voltage applying method illustrated in FIG. 6 is called pattern B. Between the patterns A and B, the pair of comb-teeth electrodes are reversed and application directions of the offset in the transverse direction are reversed.

In the first embodiment, the patterns A and B are switched. In other words, as described above, the gray-scale electrode and the reference electrode are switched between the electrodes 17 and 19 at predetermined time intervals (the voltages applied are reversed at predetermined time intervals).

The voltage setting for the electrodes in the first embodiment is as illustrated in the following Table 1. In the specification, changes of absolute values themselves of application voltages such as voltages to the electrode 17 in the pattern A and the electrode 19 in the pattern B are also reverse of the polarities of application voltages. ±0V of the electrode 19 in the pattern A and the electrode 17 in the pattern B is also reverse of the polarities of application voltages. The definition is also similarly applied to the following embodiments.

The voltages applied to the electrodes 17 and 19 are switched between the patterns A and B. Positive polarity refers to the case where a pair of electrodes is positive, and negative polarity refers to the case where the pair of electrodes is negative.

TABLE 1

| | Pattern A | | Pattern B | |
|---|---|---|---|---|
| | | Negative | | Negative |
| | Positive polarity | polarity | Positive polarity | polarity |
| (i) | 7.1 | −7.5 | 0 | 0 |
| (ii) | 0 | 0 | 7.1 | −7.5 |
| (iii) | 3.75 | −3.75 | 3.75 | −3.75 |

In the pattern A, the offset to the electrode 17 with respect to the voltage of the opposed electrode 23 is −0.2V, and the offset to the electrode 19 with respect to the voltage to the opposed electrode 23 is 0V. In the pattern B, the offset to the electrode 17 with respect to the voltage of the opposed electrode 23 is 0V, and the offset to the electrode 19 with respect to the voltage to the opposed electrode 23 is −0.2V.

In the voltage setting in Table 1, the direction of the offset of the transverse electric field (the electric field between the electrodes 17 and 19) is reversed. Consequently, as illustrated in the following Table 2, as the offset between the electrodes, the offset in the transverse direction can be eliminated as a total.

TABLE 2

| | Pattern A | Pattern B | Average |
|---|---|---|---|
| Between (i) and (ii) | −0.2 | 0.2 | 0 |

In a normal voltage application method, the positive polarity and the negative polarity of the pattern A (or pattern B) are repeated as follows.
A+→A−→A+→A−→A+−A−→

On the other hand, the voltage application methods at the time of switching the electrodes in the embodiment are as described in the following (1) and (2).

(1) relates to an example of switching the polarities once in A and switching the polarities once in B. Like in (2), switching of positive polarity and negative polarity of A may be repeated twice or more and then switching of the positive polarity and the negative polarity of B may be repeated by the same number of times as long as the numbers of A+, A−, B+, and B− are the same. Times required for A+, A−, B+, and B− are substantially the same.
(1) A+→A−→B+→B−→A+→A−→B+→B−→
(2) A+→A−→A+→A−→B+→B−→B+→B−→

A+ indicates the state where the pair of comb-teeth electrodes in the pattern A illustrated in FIG. 5 is positive. A− indicates the state where the pair of comb-teeth electrodes in the pattern A illustrated in FIG. 5 is negative. B+ indicates the state where the pair of comb-teeth electrodes in the pattern B illustrated in FIG. 5 is positive. B− indicates the state where the pair of comb-teeth electrodes in the pattern B illustrated in FIG. 5 is negative. The arrows indicate orders of changes of the voltage application state with elapse of time. It is also similarly applied to the below.

### Timing of Potential Replacement

As described above, the normal voltage applying method is repetition of positive polarity and negative polarity in the pattern A (or pattern B) as follows.
A+→A−→A+→A−→A+→A−→A+→A−→

For example, in a display driven at 240 Hz, when A and B are exchanged at 240 Hz, the pattern becomes as follows.
A+→B−→A+→B−→A+→B−→A+→B−→
   The pattern A becomes always + (positive) and the pattern B becomes always − (negative), so that the electric field slants and it is not optimum.

Therefore, exchange between A and B is preferably performed at time intervals of 120 Hz or less (the half of panel frequency or less).

When the upper limit value is 120 Hz, the following voltage applying method can be employed.
A+→A−→B+→B−→A+→A−→B+→B−→

Preferably, the lower-limit value is, for example, 0.5 Hz. More preferably, the value is 1 Hz or higher and, further more preferably, 30 Hz or higher. When the value is set to 30 Hz or higher, an effect of making a flicker inconspicuous can be displayed more remarkably.

For example, in the case of a display driven at 240 Hz or the like, it is more preferably to drive the display at 1 Hz to 120 Hz and, most preferably, to drive the display at 30 Hz to 120 Hz.

By combining the timing of the potential replacement with an image switching timing, a flicker can be further made more inconspicuous.

Generally, by normal alternating current (AC) driving (polarity inversion) used in the first embodiment and embodiments to be described later, a DC (Direct Current) component is decreased as much as possible to reduce image sticking. However, when an offset voltage is applied, it becomes a DC component to the liquid crystal, causing DC (Direct Current) image sticking.

Since a DC image sticking occurs by polarization of the insulating layer (dielectric layer) 15 due to the DC component, it is desirable that offset is as little as possible for the purpose of reducing an image sticking. It is particularly important to reduce an offset between the upper-layer electrode and the lower-layer electrode as much as possible. However, in a mode of performing driving by positively using a transverse electric field such as an on-on switching mode in the first embodiment, a flicker accompanying polarity inversion caused by flexo-electric polarization occurs. Consequently, an offset voltage for suppressing a flicker is applied.

In the first embodiment and embodiments to be described later, methods of determining a way of applying an offset voltage which does not deteriorate a visibility level of an image sticking while suppressing a flicker caused by flexo-electric polarization as much as possible are proposed.

Further, in the present embodiment, a mode where an offset is strongly applied to the reference electrode side may be adopted.

It is easy to manufacture the liquid crystal display device according to the liquid crystal driving method of the first embodiment, and higher transmittance can be achieved. While the flexo-electric polarization which is feared as the cause of a flicker is suppressed, an image sticking can be lessened. A similar effect can be displayed also in the embodiment which will be described later. In particular, in the first embodiment relating to an on-on switching mode, and a second embodiment to be described later, in a mode capable of realizing response speed at which the field sequential method can be executed, such an effect can be displayed, and it is particularly preferable.

Although not illustrated in FIGS. 1 to 6, a polarizing plate is disposed on the side opposite to the liquid crystal layers of the substrates. As the polarizing plate, any of a circular polarizing plate and a linear polarizing plate can be used. Alignment films are disposed on the side of the liquid crystal layer of both of the substrates and make the liquid crystal molecules be aligned vertical to the film surface. The alignment films may be organic alignment films or inorganic alignment films.

A voltage supplied from a video signal line at a timing when it is selected by a scanning signal line is applied to the gray-scale electrode 19 which drives the liquid crystal via a thin film transistor element (TFT). In the embodiment, the reference electrode 17 and the gray-scale electrode 19 are formed in the same layer. Although a mode that they are formed in the same layer is preferable, as long as the effect of the present invention can be displayed, the electrodes may be formed in different layers. The gray-scale electrode 19 is connected to a drain electrode extending from the TFT via a contact hole. In the first embodiment, the lower-layer electrode 13 and the opposed electrode 23 have a planar shape, and the lower-layer electrode 13, for example, can be commonly connected to even-numbered lines and to odd-numbered lines of gate bus lines. Such an electrode is also called a planar electrode in the specification. The opposed electrode 23 does not have an opening and is commonly connected in accordance with all of pixels.

The thin film transistor element will be described later. From the viewpoint of improvement of the transmittance, it is preferable to use an oxide semiconductor TFT (IGZO or the like).

In the present embodiment, the preferable electrode width L of the comb-teeth electrode is, for example, 2 μm or wider. A preferable electrode interval S between the comb-teeth electrodes is, for example, 2 μm or wider. The preferable upper-limit value is, for example, 7 μm. The preferable ratio (L/S) between the electrode interval S and the electrode width L is 0.4 to 3, for example. More preferable lower-limit value is 0.5, and more preferable upper-limit value is 1.5.

A cell gap d may be in a range of 2 μm to 7 μm. The cell gap d is preferably in the range. The cell gap d (thickness of the liquid crystal layer) is preferably calculated by averaging total thickness of the liquid crystal layer in the liquid crystal display panel in the specification.

In the liquid crystal driving method of the first embodiment, a driving operation executed by a normal liquid crystal driving method can be properly executed. The liquid crystal display device of the first embodiment can properly have members (such as a light source) provided for a normal liquid crystal display device. It is the same also in the embodiments to be described later.

### Embodiment 2 (Application of Equivalent Offsets to Electrodes 17 and 19 in Addition to Electrode Inverting Method of Embodiment 1)

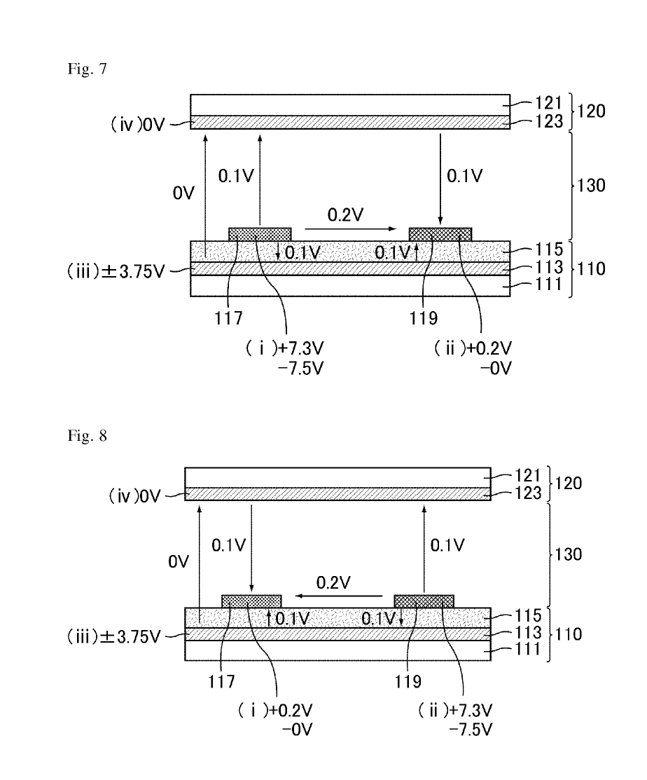

FIGS. 7 and 8 are sectional schematic diagrams illustrating a mode at the time of generation of a transverse electric field of a liquid crystal display device according to a second embodiment. In the second embodiment, a voltage applying method illustrated in FIG. 7 is called pattern A, and a voltage applying method illustrated in FIG. 8 is called pattern B. In the second embodiment, between the patterns A and B, voltages applied to electrodes 117 and 119 are replaced.

In the first embodiment, an offset voltage for solving a flicker is applied to either the electrode 17 or 19 (+200 mV). In the second embodiment, the offset voltage is equally divided to the electrodes 117 and 119 (+100 mV to each of the electrodes 117 and 119). In such a manner, an offset voltage in the vertical direction is also cancelled, so that image sticking is further suppressed.

The voltage setting for the electrodes in the second embodiment is as illustrated in the following Table 3.

The voltages applied to the electrodes 117 and 119 are switched between the patterns A and B. Positive polarity refers to the case where a pair of electrodes is positive, and negative polarity refers to the case where the pair of electrodes is negative.

TABLE 3

| | Pattern A | | Pattern B | |
|---|---|---|---|---|
| | | Negative | | Negative |
| | Positive polarity | polarity | Positive polarity | polarity |
| (i) | 7.3 | −7.5 | 0.2 | 0 |
| (ii) | 0.2 | 0 | 7.3 | −7.5 |
| (iii) | 3.75 | −3.75 | 3.75 | −3.75 |

For comparison, offsets between electrodes in the first embodiment are illustrated in the following Table 4, and offsets between electrodes in the second embodiment are illustrated in the following Table 5.

TABLE 4

| | Pattern A | Pattern B | Average |
|---|---|---|---|
| Between (i) and (ii) | −0.2 | 0.2 | 0 |
| Between (i) and (iii) | −0.2 | 0 | −0.1 |
| Between (ii) and (iii) | 0 | −0.2 | −0.1 |
| Between (i) and (iv) | −0.2 | 0 | −0.1 |
| Between (ii) and (iv) | 0 | −0.2 | −0.1 |
| Between (iii) and (iv) | 0 | 0 | 0 |

TABLE 5

| | Pattern A | Pattern B | Average |
|---|---|---|---|
| Between (i) and (ii) | −0.2 | 0.2 | 0 |
| Between (i) and (iii) | −0.1 | 0.1 | 0 |
| Between (ii) and (iii) | 0.1 | −0.1 | 0 |
| Between (i) and (iv) | −0.1 | 0.1 | 0 |
| Between (ii) and (iv) | 0.1 | −0.1 | 0 |
| Between (iii) and (iv) | 0 | 0 | 0 |

In the second embodiment, the direction of the offset of the transverse electric field (the electric field between the electrodes 117 and 119) is reversed, so that an offset in the transverse direction is eliminated as a total. Since the direction of the offset of the electrodes 117 and 119 using an opposed electrode 123 as a reference is reversed, an offset in the vertical direction is also eliminated. Consequently, image sticking can be further reduced.

The voltage applying method is similar to that at the time of replacing the electrodes described in the first embodiment. The other configuration of the second embodiment is similar to that of the above-described first embodiment.

### Third Embodiment (Case of TBA)

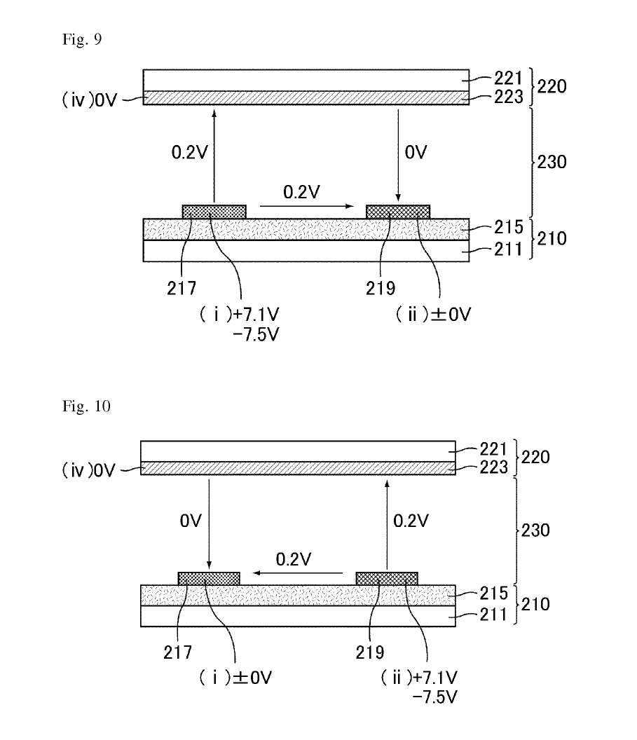

FIGS. 9 and 10 are sectional schematic diagrams illustrating a mode at the time of generation of a transverse electric field of a liquid crystal display device according to a third embodiment. The electrode structure of the third embodiment is similar to that of the first and second embodiments except that an opposed electrode is not provided for a lower-side substrate. In the third embodiment, a voltage applying method illustrated in FIG. 9 is called pattern A, and a voltage applying method illustrated in FIG. 10 is called pattern B.

The voltage setting for the electrodes in the third embodiment is as illustrated in the following Table 6. In this case, the voltage setting in the first embodiment is applied to the case of TBA.

The voltages applied to electrodes 217 and 219 are switched between the patterns A and B. Positive polarity refers to the case where a pair of electrodes is positive, and negative polarity refers to the case where the pair of electrodes is negative.

TABLE 6

| | Pattern A | | Pattern B | |
|---|---|---|---|---|
| | | Negative | | Negative |
| | Positive polarity | polarity | Positive polarity | polarity |
| (i) | 7.1 | −7.5 | 0 | 0 |
| (ii) | 0 | 0 | 7.1 | −7.5 |

Offsets between electrodes in the third embodiment are illustrated in the following Table 7.

TABLE 7

| | Pattern A | Pattern B | Average |
|---|---|---|---|
| Between (i) and (ii) | −0.2 | 0.2 | 0 |
| Between (i) and (iv) | −0.2 | 0 | −0.1 |
| Between (ii) and (iv) | 0 | −0.2 | −0.1 |

In the third embodiment, the directions of the offsets of the transverse electric fields (the electrodes 217 and 219) are reversed, so that the offset in the transverse direction is eliminated. Thus, image sticking can be reduced.

The voltage applying method is similar to that at the time of switching the electrodes illustrated in Embodiment 1, and the other configuration of the third embodiment is similar to that of the foregoing first embodiment.

### Modification of Embodiment 3 (Case of TBA)

An electrode structure of a modification of a third embodiment is similar to that of the third embodiment.

The voltage setting for the electrodes in the modification of the third embodiment is as illustrated in the following Table 8. It can be also said that the voltage setting of the second embodiment is applied to the case of TBA.

The voltages applied to a pair of electrodes are switched between the patterns A and B. Positive polarity refers to the case where a pair of electrodes is positive, and negative polarity refers to the case where the pair of electrodes is negative.

TABLE 8

| | Pattern A | | Pattern B | |
|---|---|---|---|---|
| | | Negative | | Negative |
| | Positive polarity | polarity | Positive polarity | polarity |
| (i) | 7.3 | −7.5 | 0.2 | 0 |
| (ii) | 0.2 | 0 | 7.3 | −7.5 |

Offsets between electrodes in the modification of the third embodiment are illustrated in the following table 9.

TABLE 9

| | Pattern A | Pattern B | Average |
|---|---|---|---|
| Between (i) and (ii) | −0.2 | 0.2 | 0 |
| Between (i) and (iv) | −0.1 | 0.1 | 0 |
| Between (ii) and (iv) | 0.1 | −0.1 | 0 |

Also in the modification of the third embodiment, the direction of the offset of the transverse electric field (the electric field between a pair of electrodes) is reversed, so that the offset in the transverse direction can be eliminated as a total. Since the direction of the offset using an opposed electrode of the pair of comb-teeth electrodes as a reference is reversed, the offset in the vertical direction is also eliminated.

The voltage applying method is similar to that at the time of reversing the electrodes shown in the first embodiment. The other configuration of the modification of the third embodiment is similar to the configuration of the above-described first embodiment.

Also in the TBA mode, due to the influence of flexo-electric polarization, the transmittance difference between positive and negative polarities occurs, and a flicker occurs. Consequently, by making the above-described setting at the time of applying an offset voltage to eliminate the flicker, an effect of reducing image sticking is obtained.

### (Verification of Effect of Offset Voltage)

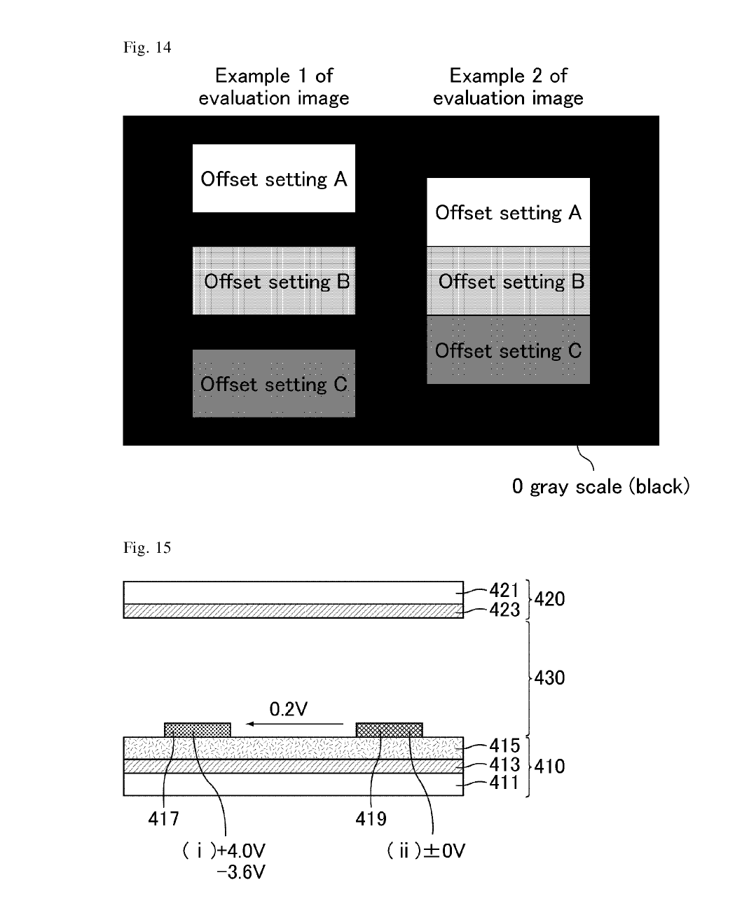

FIG. 14 is a diagram illustrating an example of an evaluation image.

As one of methods of verifying the effect of the present invention, an image sticking level determining method (with respect to the application of the offset voltage) will be described.

First, an arbitrary image sticking evaluation image is displayed. An arbitrary image sticking evaluation image is, for example, an image in which a window of a specific gray scale (for example, 255 tones: white) is displayed in the 0 gray scale (black screen) with the smallest image sticking (refer to FIG. 14).

A plurality of settings of different offset voltage applications are prepared and displayed in line in the window (refer to FIG. 14).

In a state where the evaluation images are displayed, for example, it is left for long time using a reference such as 100 hours (H), 500 hours (H), or 1,000 hours (H).

After elapse of the reference time of the image sticking evaluation, the whole screen is set to a half-tone full screen display (for example, 0 scale level, 24 scale level, 32 scale level, or the like) in which an image sticking is easily seen, and the image sticking level can be visually determined by using a filter called an ND filter.

An ND filter is a filter which decreases the light amount without exerting an influence on hue. The image sticking level is quantified in a form of percentage of an ND filter at which an image sticking becomes invisible, and image sticking levels are compared.

By comparing the image sticking level of the present offset setting with that of an offset setting different from the present offset setting, an effect of the offset setting in comparison with the turn-in level in the present offset setting can be verified.

Evaluation Result when Offset Voltages Between Electrodes are Switched

### Image-Sticking Evaluation Result Under Certain Condition

The following table 10 relates to an example of an image-sticking evaluation result after leaving 16 hours of a case where an offset voltage is applied between comb-teeth electrodes (in the table, the case is indicated as “with offset between electrodes”) and a case where the offset voltage is switched at predetermined intervals and is not applied between electrodes (in the table, the case is indicated as “without offset between electrodes”). The configuration in the case where no offset voltage is applied between electrodes (the case of “without offset between electrodes”) corresponds to that of the above-described first embodiment.

It is assumed here that as the numerical value of the image-sticking level increases, the image-sticking degree is lowered. In the case where the offset voltage is switched at predetermined intervals and is not applied between electrodes, the image-sticking degree can be made remarkably low, and display quality is excellent.

TABLE 10

| | 0 | 8 | 16 | 24 | 32 | 48 | 64 |
|---|---|---|---|---|---|---|---|
| | gray | gray | gray | gray | gray | gray | gray |
| | scale | scale | scale | scale | scale | scale | scale |
| With offset | 6 | 5 | 3 | 2 | 1 | 1 | 2 |
| between | | | | | | | |
| electrodes | | | | | | | |
| Without offset | 6 | 6 | 6 | 6 | 6 | 6 | 5 |
| between | | | | | | | |
| electrodes | | | | | | | |

By verifying the drive voltage and performing microscope observation such as SEM (Scanning Electron Microscope) observation on TFT substrate and opposite substrate, the electrode structure or the like in the liquid crystal driving method and the liquid crystal display device of the present invention can be recognized.

### COMPARATIVE EXAMPLE 1

FIG. 15 is a sectional schematic diagram of a liquid crystal display device of a transverse electric field mode according to Comparative Example 1.

This mode is the same as that in the first embodiment, and a flexo-electric polarization always occurs. Therefore, the transmittance difference accompanying inversion of the positive/negative polarity due to the flexo-electric polarization, that is, a flicker occurs. To suppress it, as illustrated in FIG. 15, it is sufficient to adjust the transmittance difference between the positive and negative polarities by applying an electric offset to electrodes. However, in the case of applying an offset voltage to one of a pair of comb-teeth electrodes, a DC image sticking caused by a DC offset becomes an issue.

### Other Preferable Embodiments

In each of the foregoing embodiments of the present invention, an oxide semiconductor TFT (such as IGZO) is preferably used. The oxide semiconductor TFT will be described below specifically.

At least one of the upper and lower substrates usually has a thin film transistor element. Preferably, the thin film transistor element includes an oxide semiconductor. That is, in a thin film transistor element, it is preferable to form an active layer of an active drive element (TFT) by using an oxide semiconductor film made of zinc oxide or the like in place of a silicon semiconductor film. Such TFT is called “oxide semiconductor TFT”. The oxide semiconductor has characteristics that the oxide semiconductor displays carrier mobility higher than that of amorphous silicon and its characteristic variation is also smaller. Consequently, an oxide semiconductor TFT can operate at speed higher than an amorphous silicon TFT, has high drive frequency, and is suitable for driving a higher-definition next-generation display device. Since the oxide semiconductor film is formed by a process simpler than that for a polysilicon film, it has an advantage that it can be also applied to a device requiring large area.

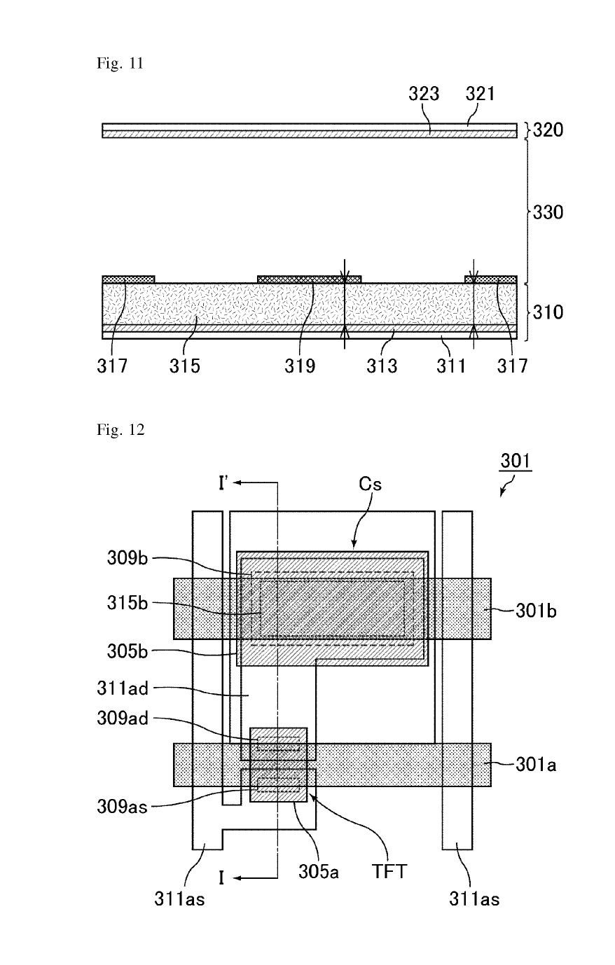

Particularly, in the case of using the liquid crystal driving method of the embodiment to an FSD (Field Sequential Display device), the following characteristics become remarkable.
(1) The pixel capacity is larger than that in a normal VA (Vertical Alignment) mode (FIG. 11 is a sectional schematic diagram illustrating an example of a liquid crystal display device used for the liquid crystal driving method of the embodiment. Since a large capacitance is generated between an upper-layer electrode and a lower-layer electrode in parts indicated by the arrows in FIG. 11, the pixel capacitance is larger than that in a liquid crystal display device in a normal vertical alignment (VA) mode).
(2) Since three pixels of R, G, and B become one pixel, the capacitance of one pixel is three times.
(3) Further, driving at 240 Hz or higher is necessary, so that gate-on time is very short.

Moreover, the merits in the case of applying an oxide semiconductor TFT (such as IGZO) are as follows.

By the above reasons (1) and (2), the pixel capacitance in a 52-inch device is about 20 times as large as that of a model of 240 Hz driving of UV2A.

Therefore, when a transistor is fabricated by a-Si in a conventional manner, the transistor becomes larger by about 20 times or more, and a problem occurs that the aperture ratio is not sufficient.

Since the mobility of IGZO is about ten times as that of a-Si, the size of the transistor becomes about 1/10.

Since three transistors provided in a liquid crystal display device using color filter RGB become one, a transistor can be fabricated in a size almost equal to or smaller than the size of a-Si.

When a transistor becomes smaller as described above, the capacitance of Cgd decreases, thereby making the burden on a source bus line be smaller by the decreased amount.

### CONCRETE EXAMPLE

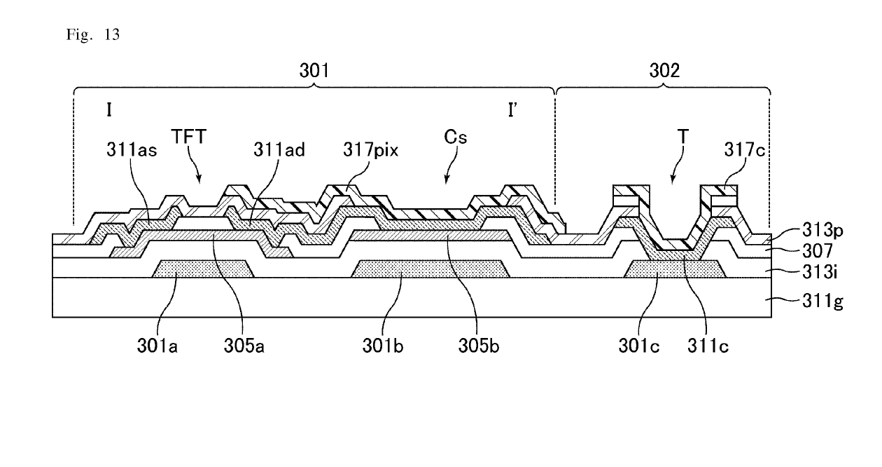

FIGS. 12 and 13 are configuration diagrams (illustrations) of an oxide semiconductor TFT. FIG. 12 is a plan schematic view of the periphery of an active driving element used for the embodiment. FIG. 13 is a sectional schematic diagram illustrating the periphery of an active driving element used for the embodiment. Reference character T indicates gate/source terminals. Reference characters Cs denote auxiliary capacitance.

An example (the part) of a process of fabricating an oxide semiconductor TFT will be described below.

Active layer oxide semiconductor layers 305a and 305b in an active drive element (TFT) using an oxide semiconductor film can be formed as follows.

First, by using the sputtering method, for example, an In—Ga—Zn—O semiconductor (IGZO) film having a thickness of 30 nm or larger and 300 nm or less is formed on an insulating film 313i. After that, by photolithography, a resist mask covering a predetermined region in the IGZO film is formed. Subsequently, a part which is not covered with the resist mask in the IGZO film is removed by wet etching. After that, the resist mask is peeled off. In such a manner, the oxide semiconductor layers 305a and 305b each having an island shape are obtained. In place of the IGZO film, the oxide semiconductor layers 305a and 305b may be formed by using another oxide semiconductor film.

Subsequently, an insulating film 307 is deposited on the entire surface of a substrate 311g and, after that, the insulating film 307 is patterned.

Concretely, first, over the insulating film 313i and the oxide semiconductor layers 305a and 305b, for example, an SiO₂ film (having a thickness of, for example, about 150 nm) is formed as the insulating film 307 by the CVD method.

Preferably, the insulating film 307 includes an oxide film of SiOy or the like.

When an oxide film is used, in the case where an oxygen defect occurs in the oxide semiconductor layers 305a and 305b, the oxygen defect can be recovered by oxygen included in the oxide film. Therefore, an oxygen defect in the oxide semiconductor layers 305a and 305b can be reduced more effectively. Although a single layer including an SiO₂ film is used as the insulating film 307, the insulating film 307 may have a layer-stack structure using an SiO₂ film as a lower layer and an SiNx film as an upper layer.

Preferably, the thickness of the insulating film 307 (in the case where the layer has the layer-stack structure, total thickness of the layers) is 50 nm or larger and 200 nm or less. When the thickness is 50 nm or larger, the surface of the oxide semiconductor layers 305a and 305b can be protected more reliably in a process of patterning a source/drain electrode and the like. On the other hand, when the thickness exceeds 200 nm, a large step occurs by a source electrode and a drain electrode. Consequently, there is the possibility that disconnection or the like is caused.

Preferably, the oxide semiconductor layers 305a and 305b in the embodiment are layers made of, for example, Zn—O semiconductor (ZnO), In—Ga—Zn—O semiconductor (IGZO), In—Zn—O semiconductor (IZO), Zn—Ti—O semiconductor (ZTO), or the like. Particularly, the In—Ga—Zn—O semiconductor (IGZO) is more preferable.

Although the mode produces a predetermined operation effect by a combination with the oxide semiconductor TFT, driving can be also performed by using a known TFT element such as amorphous SiTFT or polycrystal SiTFT.

Although the mode that the opposed substrate has no overcoat layer has been described in each of the foregoing embodiments, an overcoat layer may be provided.

Although ITO (Indium Tin Oxide) can be used as an electrode material, in place of ITO, a known material such as IZO (Indium Zinc Oxide) or the like can be employed.

The liquid crystal driving method and the liquid crystal display device of the present invention can be applied also to a liquid crystal display device of another transverse electric field method in which liquid crystal molecules are not aligned in the vertical direction at the time of no voltage application. For example, they can be also applied to a liquid crystal display device in the IPS mode.

The liquid crystal driving method of the present invention may execute a driving operation for driving a liquid crystal by causing a potential difference between a pair of electrodes and applying a fringe electric field between the pair of electrodes and planar electrode.

### REFERENCE SIGNS LIST

10, 110, 310, 310, 410: array substrate (lower substrate)
11, 21, 111, 121, 211, 221, 311, 321, 411, 421: glass substrate
13, 113, 313, 413: lower-layer electrode (planar electrode)
15, 115, 215, 315, 415: insulating film
16: a pair of comb-teeth electrodes
17, 19, 117, 119, 217, 219, 317, 319, 417, 419: electrode
20, 120, 220, 320, 420: opposed substrate (upper substrate)
23, 123, 223, 323, 423: opposed electrode
30, 130, 230, 330, 430: liquid crystal layer
31: liquid crystal (liquid crystal molecules)
301a: gate wiring
301b: auxiliary capacitance wiring
301c: connection part
311g: substrate
313i: insulating film (gate insulating film)
305a, 305b: oxide semiconductor layer (active layer)
307: insulating film (etching stopper, protection film)
309as, 309ad, 309b, 315b: opening
311as: source wiring
311ad: drain wiring
311c, 317c: connection part
313p: protection film
317pix: pixel electrode
301: pixel part
302: terminal disposing region
Cs: auxiliary capacitance
T: gate/source terminal

1. A liquid crystal driving method of driving liquid crystal by causing a potential difference between a pair of electrodes provided for one of upper and lower substrates, wherein polarity of each of application voltages to the pair of electrodes is inverted, a planar electrode is provided for the upper substrate and/or the lower substrate,
when a difference obtained by subtracting a voltage applied to the planar electrode from an average value of a positive voltage and a negative voltage applied to one of the pair of electrodes is set as a first offset voltage and a difference obtained by subtracting a voltage applied to the planar electrode from an average value of a positive voltage and a negative voltage applied to the other one of the pair of electrodes is set as a second offset voltage, a driving operation is executed so that the values of the first and second offset voltages are switched with each other.

2. The liquid crystal driving method according to claim 1, wherein a planar electrode is provided for at least the other one of the upper and lower substrates, a difference obtained by subtracting a voltage applied to the planar electrode provided for the other one of the upper and lower substrates from an average value of a positive voltage and a negative voltage applied to one of the pair of electrodes is set as a first offset voltage, and a difference obtained by subtracting the voltage applied to the planar electrode provided for the other one of the upper and lower substrates from an average value of a positive voltage and a negative voltage applied to the other one of the pair of electrodes is set as a second offset voltage.

3. The liquid crystal driving method according to claim 1, wherein the polarity of the first offset voltage and that of the second offset voltage are opposite to each other and the absolute value of the first offset voltage and that of the second offset voltage are the same.

4. The liquid crystal driving method according to claim 1, wherein the driving operation is executed so that the value of the first offset voltage and that of the second offset voltage are switched with each other at predetermined time intervals.

5. The liquid crystal driving method according to claim 1, wherein the pair of electrodes is a pair of comb-teeth electrodes.

6. The liquid crystal driving method according to claim 1, wherein planar electrodes are provided for both of the upper and lower substrates and, after the driving operation, further, a driving operation of driving liquid crystal is executed by causing a potential difference between a pair of electrodes constructed by the planar electrodes provided for both of the upper and lower substrates.

7. The liquid crystal driving method according to claim 1, wherein a planar electrode is disposed for only the other one of the upper and lower substrates.

8. The liquid crystal driving method according to claim 1, wherein the liquid crystal includes liquid crystal molecules aligned in a direction perpendicular to a substrate main surface when no voltage is applied.

9. The liquid crystal driving method according to claim 1, wherein a dielectric layer is provided for at least one of the upper and lower substrates.

10. The liquid crystal driving method according to claim 1, wherein one of the upper and lower substrates has a thin film transistor element, and
the thin film transistor element includes an oxide semiconductor.

11. A liquid crystal display device driven by using a liquid crystal driving method according to claim 1.
